(19) United States
(12) Patent Application Publication
(10) Pub. No.: US 2008/0030341 A1
(43) Pub. Date: Feb. 7, 2008

(54) ELECTRONIC RACK AND MATERIAL MANAGEMENT SYSTEMS UTILIZING THE SAME

(75) Inventor: Jia-He Zhuang, Taoyuan County (TW)

Correspondence Address: THOMAS, KAYDEN, HORSTEMEYER & RISLEY LLP, 600 GALLERIA PARKWAY, 15TH FLOOR, ATLANTA, GA, 30339, US

(73) Assignee: TAIWAN SEMICONDUCTOR MANUFACTURING CO., LTD., Hsin-Chu (TW)

(21) Appl. No.: 11/669,220

(22) Filed: Jan. 31, 2007

Related U.S. Application Data
(60) Provisional application No. 60/821,142, filed on Aug. 2, 2006.

(51) Int. Cl. G08B 13/14; G08B 5/22

(52) U.S. Cl. 340/572.7; 340/572.1

(57) ABSTRACT

An electronic rack includes a frame with a plurality of containers each for receiving a wafer carrier. A sensor is associated with at least one of the containers and reads ID information corresponding to a wafer carrier received by the associated container. A display shows related information of the wafer carrier based on the read ID information.

### BACKGROUND OF THE INVENTION

1. Field of the Invention

The invention relates to computer techniques, and more particularly to manufacturing process management.

2. Description of the Related Art

As semiconductor products are increasingly designed to be smaller, manufacturing processes thereof become more complicated, typically from 100 stages ten years ago, and to around 400 stages today. Wafer carriers, such as pods, or front opening unified pods (FOUP), carry wafers from one manufacturing stage to another. Some wafer carriers may be stacked in stockers or on racks before entering the next manufacturing stage. Wafer lots in these carriers must be identifiable such that, when necessary, a desired wafer carrier can be retrieved from the stockers or racks and transported by an operator, robots, or other transportation tools, such as a trolley to a next manufacturing stage. A computer integrated manufacturing (CIM) system may be queried for positions of wafer lots possessed in manufacturing equipment and stockers, but cannot accurately tracks those wafer lots carried by operators, trolleys, or those stacked on racks. Statistically, percentages of wafer lots in a foundry distributed among various transporters (such as trolleys and operators), racks, equipment, and stockers respectively are 24%, 35%, 12%, and 29%. Thus, more than half of wafer lots (i.e. 24%+35%) in a foundry are not under the control of the CIM system.

A wafer carrier equipped with a Smart-tag can display wafer information such as wafer lot identification (ID) when a button thereon is pressed, assisting in location of wafer lots. For example, the position of a desired wafer lot can be located by querying the CIM system for its previously processed equipment and by pressing the Smart-tag buttons of wafer carriers on racks nearby equipment. Locating a desired wafer lot by pressing buttons on wafer carriers one by one, and from rack to rack, is however, time consuming. Provided that three locations each with three racks are near the equipment, and each rack holds 16 wafer carriers, in the worst case number of button presses required to search the lot would be 3*3*16=144.

Additionally, a record of manufacturing information associated with a wafer lot may be updated or changed for some reason while the Smart-tag of the wafer lot still presents old manufacturing information. This may cause operational errors. Moreover, wafers in a wafer carrier having a Smart-tag with a dead battery are unrecognizable.

Because thousands of wafer lots may be distributed at different locations in a foundry, such as being processed by manufacturing equipment in respective stages, transported by trolleys or operators, stacked in stockers, on racks, or others, thus, locating a wafer lot may be difficult.

### BRIEF SUMMARY OF THE INVENTION

A detailed description is given in the following embodiments with reference to the accompanying drawings.

An exemplary embodiment of an electronic rack comprises a frame with a plurality of containers for receiving wafer carriers. A sensor is associated with at least one of the containers and reads ID information corresponding to a wafer carrier received by the associated container. A display shows related information of the wafer carrier based on the read ID information.

An exemplary embodiment of an electronic rack comprises a frame with a plurality of containers. Each container provides corresponding position information and is configured for receiving a wafer carrier with corresponding process information stored in a database. A sensor associated with one of the containers reads ID information corresponding to a wafer carrier received by the associated container. A communication unit transmits the ID information and corresponding position information of the container to update corresponding process information of the wafer carrier in the database.

An exemplary embodiment of a material management system comprises a database storing process information of wafer lots, a server coupled to the database, and an electronic rack. The electronic rack comprises a plurality of containers, each provided with corresponding position information and configured for receiving a wafer carrier with corresponding process information stored in the database. The electronic rack further comprises a communication unit and a sensor associated with one of the containers. The sensor reads ID information corresponding to a wafer carrier received by the associated container. The communication unit transmits the ID information and corresponding position information of the container to the server to update corresponding process information of the wafer carrier in the database.

### BRIEF DESCRIPTION OF THE DRAWINGS

The invention can be more fully understood by reading the subsequent detailed description and examples with references made to the accompanying drawings, wherein:

FIG. 1 is a block diagram of the configuration of an exemplary embodiment of an electronic rack coupled to a material management system;

FIG. 2A is a schematic view showing exemplary read ranges of RFID readers with respect to wafer carrier containers;

FIG. 2B is a schematic view showing alternative read ranges of RFID readers with respect to wafer carrier containers;

FIG. 3A is a schematic view showing an exemplary embodiment of an electronic rack;

FIG. 3B is a schematic view showing a portion of the electronic rack;

FIG. 3C is a schematic view showing a display associated with a container on the electronic rack showing wafer lot information;

FIG. 4 a schematic view showing an exemplary embodiment of a wafer carrier;

FIG. 5A a schematic view showing a cover of the door of an exemplary embodiment of the wafer carrier;

FIG. 5B a schematic view showing a portion of the cover comprising a tag holder and an RFID tag;

FIG. 5C a schematic view showing the RFID tag mounted on the tag holder;

FIG. 6 is a flowchart showing the operations between an exemplary embodiment of the electronic rack and the material management system;

FIG. 7 is a flowchart showing another exemplary embodiment of the operations between another exemplary embodiment of the electronic rack and the material management system;

FIG. 8 is a flowchart showing operations between another exemplary embodiment of the electronic rack and the material management system; and

FIG. 9 is a block diagram of the configuration of another exemplary embodiment of an electronic rack.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

. . .

System Overview

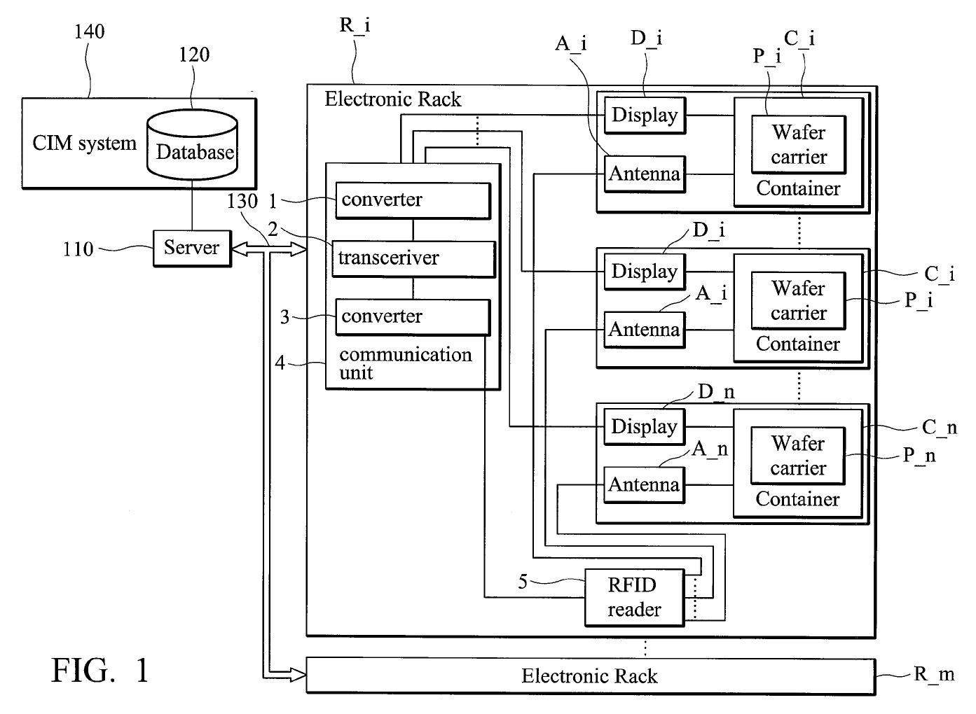

With reference to FIG. 1, electronic rack R_1 is connected to server 110 through communication channel 130. Server 110 acts as a bridge between racks (such as electronic racks R_1˜R_m, where m is a natural number) and CIM system 140, which includes database 120. For example, server 100 may comprise a material control system (MCS) connected to an automatic material handling system (AMHS). Channel 130 may comprise a wired or wireless channel. For example, server 110 and racks R_1˜R_m may be connected to a local area network (LAN) or wireless LAN.

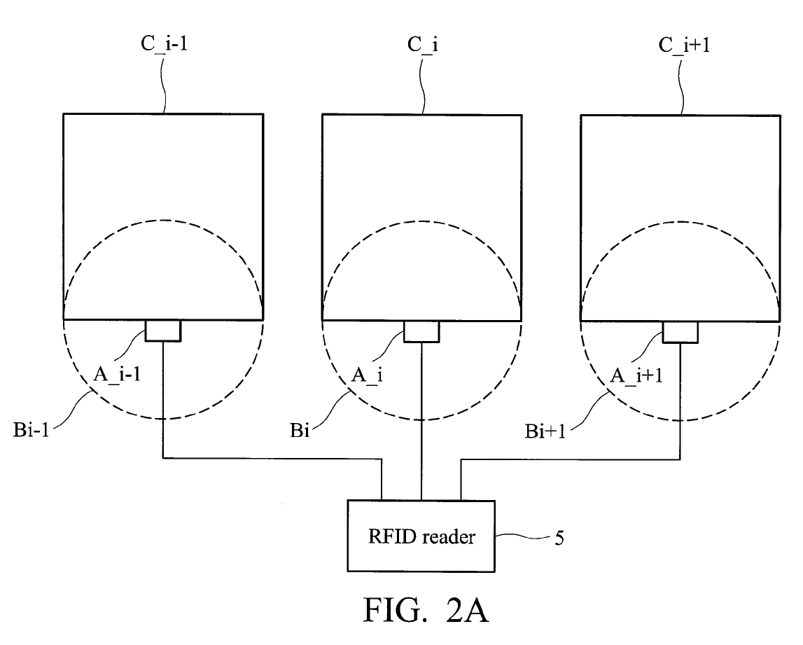

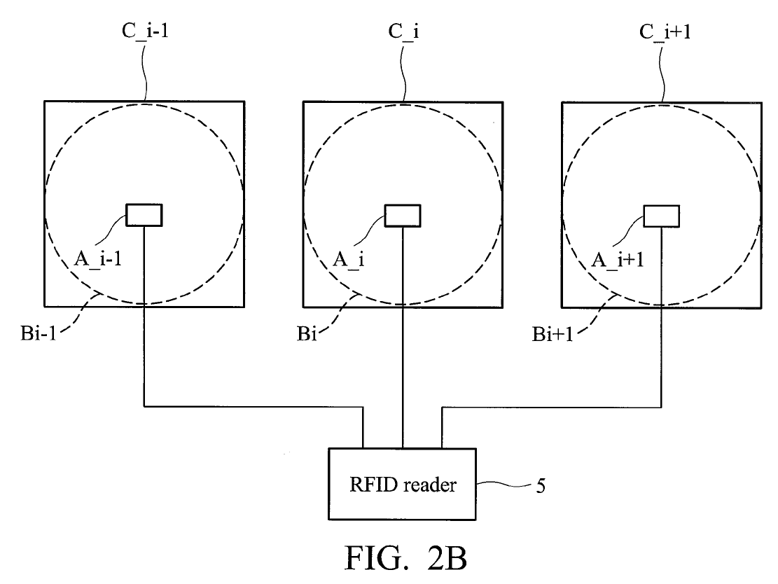

An electronic rack comprises a frame with a plurality of containers for wafer carriers (such as pods or FOUPs). Each container is configured to receive a wafer carrier and associated with a sensor and a display, respectively for reading ID information corresponding to the wafer carrier and showing related information of the wafer carrier based on the read ID information. A sensor controller may be utilized to conduct these sensors. Rack R_1 is an example of an electronic rack for receiving wafer carriers. The RFID (Radio Frequency Identification) sensors are implemented by antennas and connected to the sensor controller. In rack R_1, container C_1 is associated with display D_1 and antenna A_1. Similarly, a second container of rack R_1 is associated with a second display and a second antenna, and container C_n is associated with display D_n and antenna A_n, where n is a positive integer greater than one. Generally, container C_i is associated with display D_i and antenna A_i, where variable i is within a natural number domain, and 0≦i≦n. Each antenna is provided with limited read range such that two wafer carriers in neighboring containers associated with two adjacent antennas can be successively detected thereby without tag or reader conflicts. RFID antennas provide radio frequency about ≦125 KHz. Preferably an RFID reader providing SLF (super low frequency, ranging from 30 Hz to 300 Hz) is utilized. FIGS. 2A and 2B show two examples of reader read ranges with respect to wafer carrier containers. An antenna (such as A_i) may be located in various areas of or closing to a corresponding container (such as C_i). Preferably the read range (such as Bᵢ) of the antenna is kept away from any adjacent container (such as containers C_i−1 and C_i+1) of the corresponding container, and any two neighboring read ranges (such as Bᵢ₋₁ and Bᵢ, or Bᵢ and Bᵢ₊₁), no matter how closely they are located in a horizontal or vertical direction, do not overlap.

Each antenna is provided with position information corresponding to the associated container thereof. For example, the position information of antenna A_i may be the combination of the ID information of rack R_i and container C_i., ID information of reader 5 and antenna A_i., or various combinations thereof.

When detecting a wafer carrier with an RFID tag in the read range of an antenna (such as A_i), the antenna receives ID and other information therefrom corresponding to the wafer carrier. RFID reader 5 serving as a sensor controller to control antennas A_1˜A_n then reads and transmits received ID information and the position of the antenna to communication unit 4. Communication unit 4 receives and transmits the ID and position information to server 110 through channel 130. RFID reader 5 may interrogate antennas A_1 to A_n successively or simultaneously to determine which antenna receives data from a tag. In a case of successively interrogating antennas, reader 5 may couple to a multiplexer (not shown) for selecting an antenna to be activated in a time frame. Note that different sensors, such as infrared sensors or barcode readers, may replace RFID reader 5 and the antennas thereof.

A communication unit (such as communication unit 4) in an electronic rack transmits the position and ID information read by a sensor (such as antenna A_i and RFID reader 5) to database 120 to update corresponding process information therein of the wafer lot in a wafer carrier detected by the sensor. A communication unit (such as communication unit 4) in an electronic rack receives data pushed by or pulled from CIM system 140 (such as data pushed or responded to by database 120) and transfers the data to a display (such as display D_i) to be present. For example, transceiver 2 in FIG. 1 performs the data transmission and receiving between server 110 and rack R_1.

Format conversion may be required before data transmission to channel 130. For example, when connecting to reader 5 through RS232 (recommended standard 232) protocol and to server 110 through TCP/IP (transmission control protocol/Internet protocol), communication unit 4 converts the received information from RS232 protocol to TCP/IP before transmission thereof to server 110. The conversion may generate outgoing TCP/IP packets carrying the information. Converter 1 may perform the format conversion for outgoing packets. Note that other Ethernet protocols may be utilized between the electronic racks and server 110.

Format conversion may also be required after receiving data from server 110. For example, when connecting to server 110 through TCP/IP and to display D_i through RS485 (recommended standard 485) protocol, communication unit 4 converts the received data in incoming packets from TCP/IP to RS485 before transmission thereof to display D_i. Converter 3 may perform the format conversion for incoming packets.

An Exemplary Electronic Rack

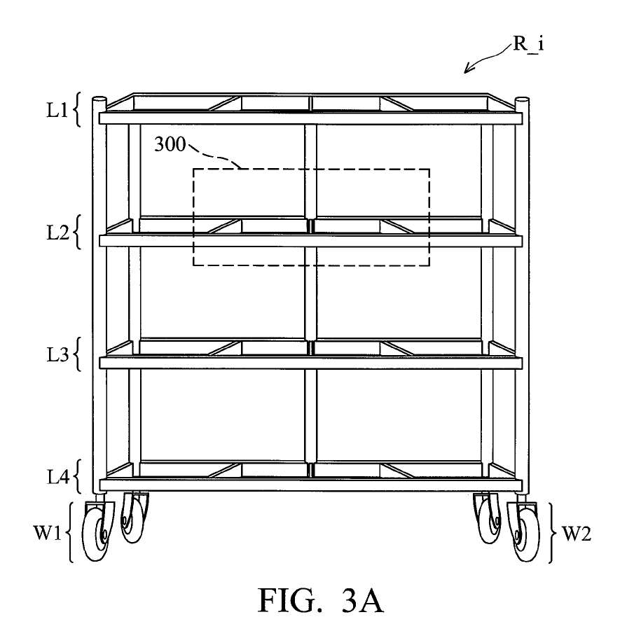

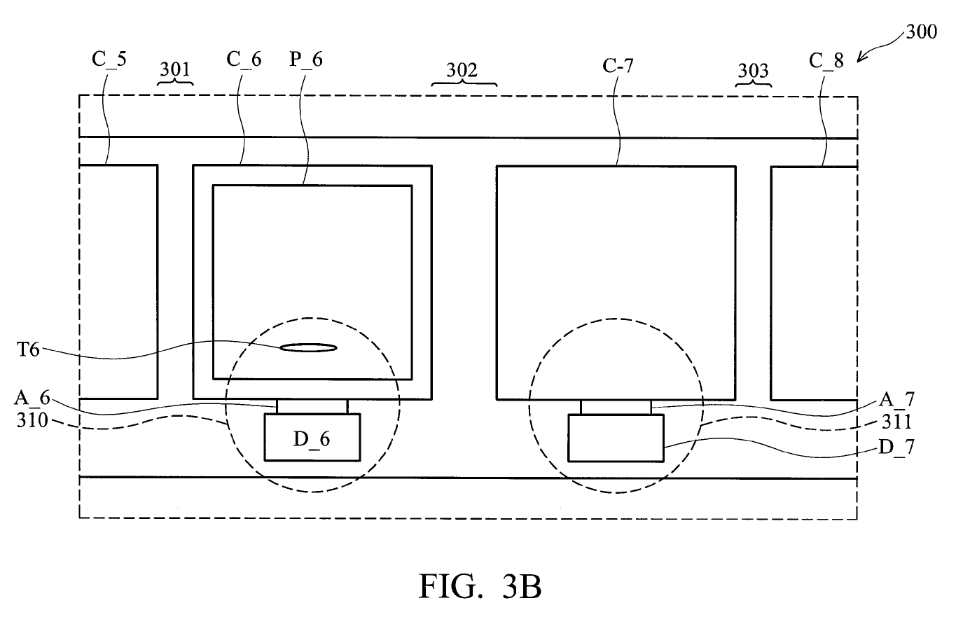

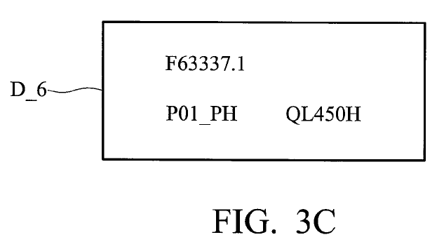

With reference to FIG. 3A, rack R_i comprises a frame with four layers L1˜L4, and four wheels (comprising W1 and W2). Each layer comprises four containers. Note that an electronic rack may comprise any number of wheels or none; the frame may be variously configured to include any number of containers in layer. A top view of a portion of layer L2 is shown in FIG. 3B. Separations divided by partitions on a layer form containers. For example, containers C_5, C_6, C_7, and C_8 are separated by partitions 301, 302, and 303. Display D_6 and antenna A_6 is associated with container C_6. Display D_7 and antenna A_7 is associated with container C_7. When wafer carrier P_6 is put on container C_6, tag T6 associated therewith is in the read range 310 of reader 5. Thus, reader 5 in FIG. 1 detects an RFID tag T6 associated with carrier P_6 through antenna A_6, and display D_6 shows related wafer lot information of carrier P_6 in response to the detection. Since contain C_7 has no wafer carrier, antenna A_7 receives no RFID tag information, and display D_7 does not show any wafer lot information. Note that the read range 311 of antenna A_7 cannot reach the domain of container C_6, thus to prevent antenna A_7 from reading tag T6.

With reference to FIG. 3C, display D_6 shows wafer lot number F63337.1, manufacturing stage PO1_PH, and program QL450H. Note that display D_6 may show more related wafer lot information. A display (such as D_i) associated with a container (such as C_i) may comprise a liquid crystal display (LCD), organic light emitting diode (OLED) display, e-paper display, or any other display. Each display may have an embedded controller. Server 110 may control the displays on each electronic rack through the embedded controllers, transmit content thereto for display, and clear the displays.

An Exemplary Wafer Carrier

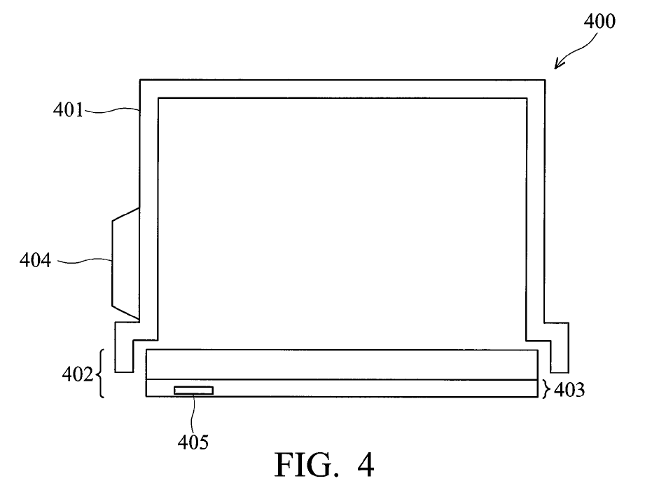

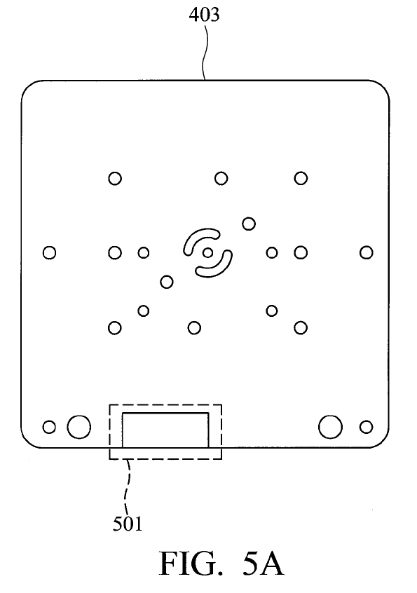

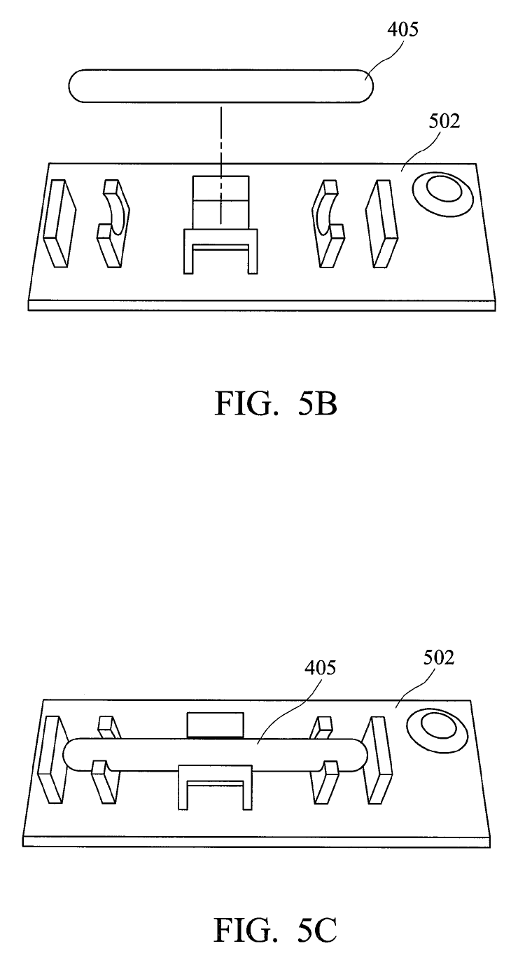

With reference to FIG. 4, wafer carrier 400 comprises shell 401 and door 402 and may be associated with identification device 404 such as a Smart-tag. Note that identification device 404 is optional to wafer carrier 400. A cassette (not shown) for holding wafers may be disposed in shell 401. Door 402 further comprises a cover 403. With reference to FIGS. 5A˜5C, cover 403 comprises a tag holder 502 in area 501. Tag holder 502 receives RFID tag 405. Note that tag holder 502 may be designed in different structure and formed on another area of cover 403. The location of area 501 on cover 403 must be well allocated to ensure tag 405 is readable by reader 5 through antenna A_i (i.e. in the read range thereof) when wafer carrier 400 is in container C_i.

Tag 405 is preferably implemented by a passive tag, which has no power source but utilizes the electromagnetic waves from a reader to energize the chip in the tag and returns data therein. Cover 403 is preferably made up of transparent materials.

Rack Operations

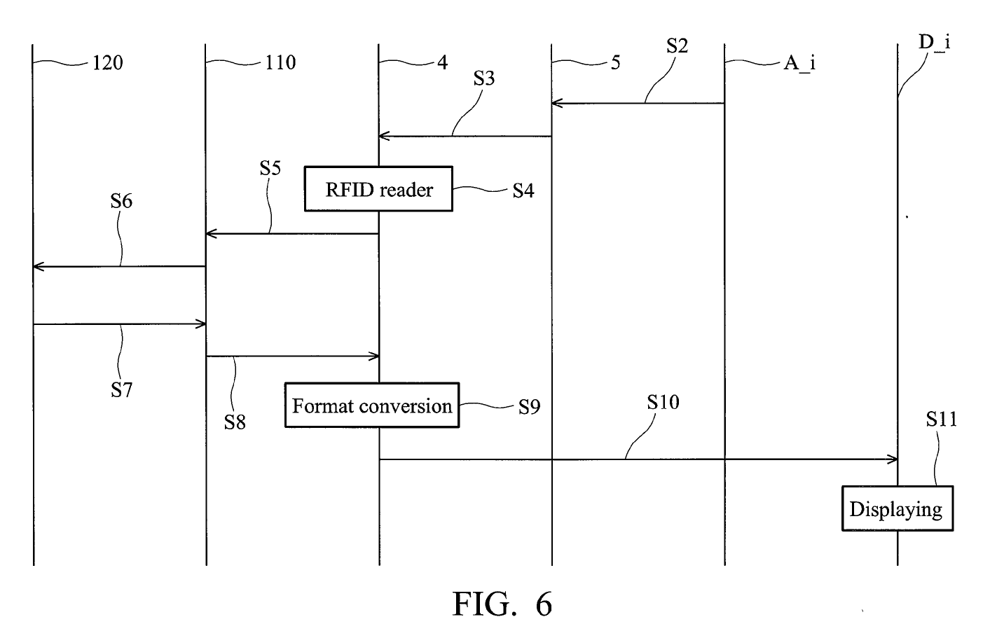

Display D_i may initially display nothing when no wafer carrier is placed on container C_i. Reader 5 emits radio waves through antenna A_i to interrogate an RFID tag. With reference to FIG. 6, when wafer carrier P_i is put on container C_i, an RFID tag associated with wafer carrier P_i falls in the read range of antenna A_i and returns data in the chip of the tag to RFID reader 5. RFID reader 5 receives the data (such as the ID number and other information of wafer lot in wafer carrier P_i) from the RFID tag though antenna A_i (step S2). The received data is referred to as lot information corresponding to wafer carrier P_i. Reader 5 transmits the lot information and position information of antenna A_i to communication unit 4 (step S3). Communication unit 4 receives the lot information and the position information, converts them from a first protocol for reader 5 to a second protocol for channel 130 (step S4), and transmits the converted lot information to server 110 through channel 130 (step S5).

In response to reception of the converted lot information, server 110 transmits the converted lot information to database 120 (step S6) to update process information therein corresponding to the wafer lot in wafer carrier P_i and retrieves a portion of the process information from database 120 (step S7). In step S6, database 120 may locate a process information record based on lot information of wafer carrier P_i and utilize the position information thereof to update the current position of the wafer lot carried by wafer carrier P_i.

Server 110 transmits the retrieved process information to communication unit 4 (step S8). Communication unit 4 converts the process information form the second protocol for channel 130 to a third protocol for display D_i (step S9) and transfers the converted process information to display D_i to be present (steps S10 and S11). For example, the second protocol may be an Ethernet protocol. The first and third protocols may respectively comprise RS232 and RS485 protocols. The process information may be the ID information of a manufacturing stage of the wafer lot. For example, process information may be the ID information of a piece of equipment which wafer carrier P_i is to enter or a piece of equipment that previously processed the wafer lot. Display D_i can provide more information other than process information. For example, display D_i shows an ID number (such as shown in FIG. 3) of the wafer lot P_i, which is provided by reader 5. The information shown on display D_i is referred to as related information of wafer carrier P_i.

Display D_i may keep displaying the related information until the RFID tag associated with wafer carrier P_i is out of the read range corresponding to antenna A_i.

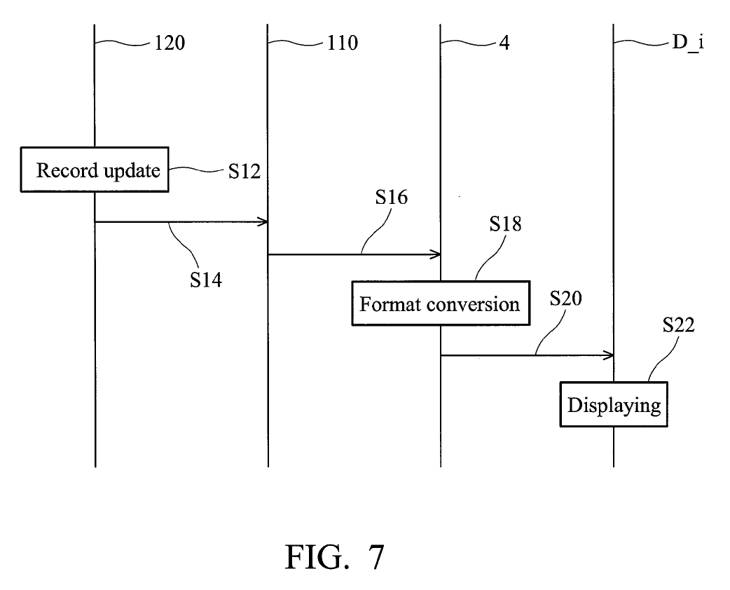

CIM system 140 may push process information to rack R_i (such as data pushed to or responded to by database 120). With reference to FIG. 7, a process information record in database 120 is updated by equipment or an operator (step S12). In response to the update of a process information record corresponding to wafer carrier P_i, server 110 retrieves the updated process information from database 120 (step S14) and transmits the updated process information to communication unit 4 (step S16). Communication unit 4 converts the process information from channel 130 of the second protocol to the third protocol for the display D_i (step S18) and transfers the converted process information to display D_i (step S20). Display D_i shows the converted process information (step S22).

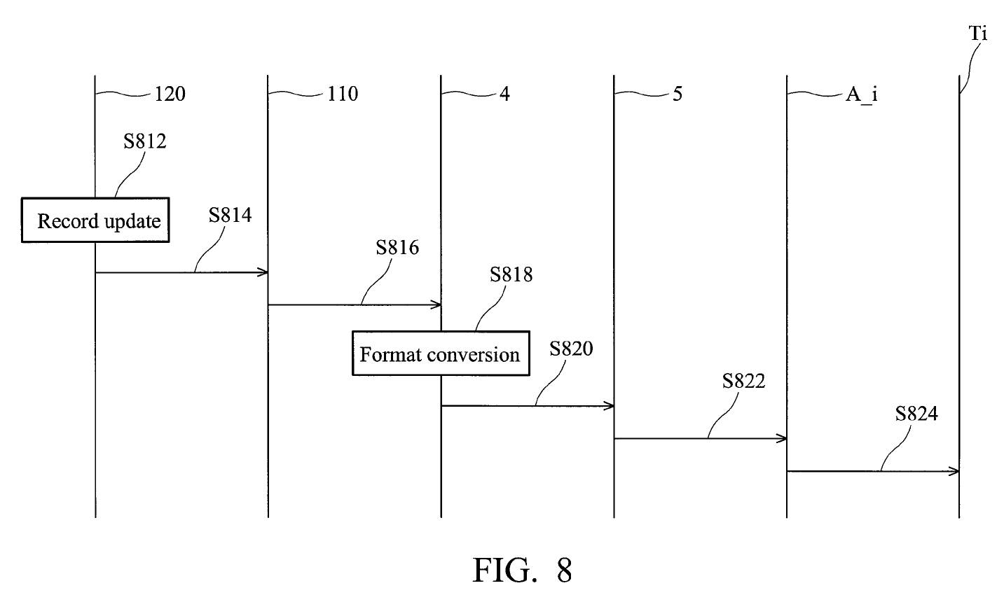

CIM system 140 may write data to tags or other storage medium on rack R_i through server 100. With reference to FIG. 8, a record corresponding to wafer carrier P_i in database 120 is updated by manufacturing equipment or an operator (step S812). In response to the record update, server 110 retrieves updated data in the record from database 120 (step S814) and transmits the updated data to communication unit 4 (step S816). Communication unit 4 converts the data from the channel 130 of the second protocol to the first protocol for reader 5 (step S818) and transfers the converted data thereto (step S820). Reader 5 writes the converted data to tag T1 through antenna A_i (steps S822 and S824). Reader 5 or any other output unit on the rack may write a portion of the corresponding process information to tags or other storage media associated with containers.

Transmission of the updated process information to rack R_i may be executed by server 110 automatically or triggered based on user demands.

Variations

RFID reader 5 may couple an antenna to a display to enable immediate presentation by the display of wafer lot information (such as ID of the wafer lot) from the antenna without querying database 120. For example, display D_i shows ID information of wafer lot P_i as soon as antenna A_i receives the ID information.

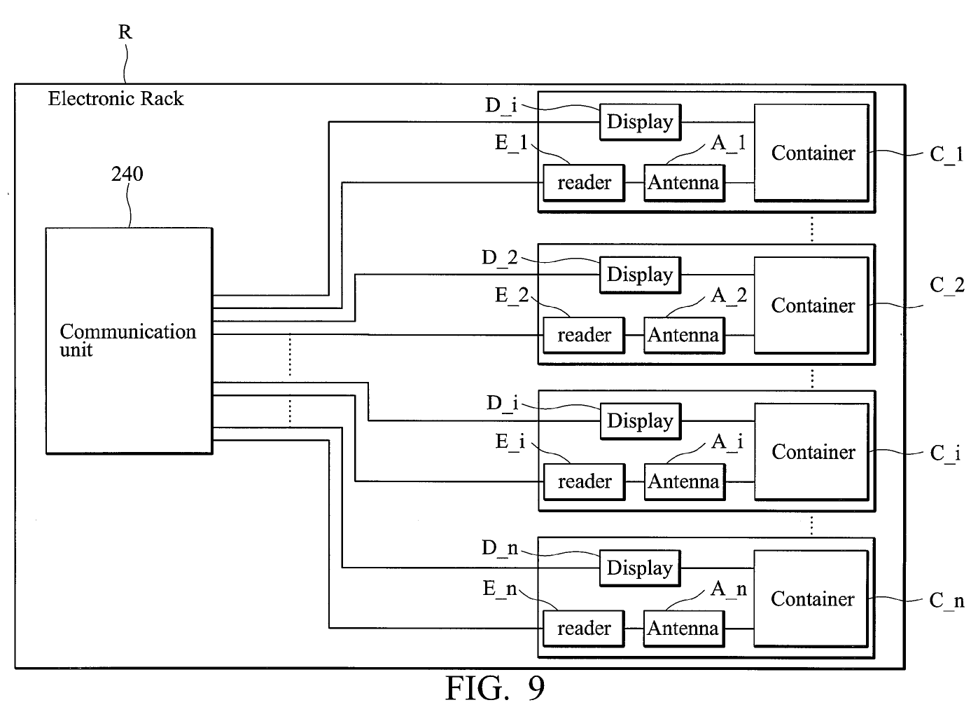

FIG. 9 shows another exemplary embodiment of an electronic rack R, wherein an antenna is coupled to a dedicated RFID reader. Reader E_1˜E_n are coupled to communication unit 240. Communication unit 240 acts as unit 4 to communicate with server 110.

An RFID tag may have two forms of memory; a programmable chip and a form of read-only memory containing a unique serial number embedded at the factory.

### CONCLUSION

Because sensors are installed on an electronic rack, and tags are attached to wafer carriers, the electronic rack can report the current positions of received wafer lots to a CIM database. Wafer lots stacked on the electronic rack can thus be tracked. The electronic rack may also comprise displays to show related information of received wafer lots. Display of the related information may be activated or deactivated in response to sensor detection.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic rack, comprising:
a frame with a plurality of containers each for receiving a wafer carrier;
a sensor having an antenna of an RFID reader associated with one of the containers, for reading ID information corresponding to a wafer carrier received by the associated container; and
a display showing related information of the wafer carrier based on the read ID information, wherein the sensor and the display are both in the electronic rack.

2. The electronic rack as claimed in claim 1, wherein the container is provided with corresponding position information, further comprising:
a communication unit transmitting the ID information and corresponding position information of the container to update corresponding process information of the wafer carrier in a database.

3. The electronic rack as claimed in claim 1, further comprising:
a communication unit transmitting the ID information through a channel to a server to query and receive the related information of the wafer carrier from a database.

4. The electronic rack as claimed in claim 3, wherein the communication unit transmits the ID information through a wired or wireless channel.

5. The electronic rack as claimed in claim 3, wherein the communication unit converts the ID information from a first protocol for the sensor to a second protocol for the channel, and converts the related information of the wafer carrier from the second protocol to a third protocol for the display.

6. The electronic rack as claimed in claim 5, wherein the communication unit converts the ID information from RS232 protocol to Ethernet protocol, and converts the related information of the wafer carrier from the Ethernet protocol to RS485 protocol for the display.

7. The electronic rack as claimed in claim 1, wherein the display keeps displaying the related information when the ID information corresponding to the wafer carrier is readable by the sensor.

8. The electronic rack as claimed in claim 7, wherein the display keeps displaying the related information when an RFID tag comprising the ID information and attached to the wafer carrier is in the read range of the RFID reader.

9. The electronic rack as claimed in claim 8, wherein the RFID reader connects to a plurality of antennas serving as sensors one-to-one associated to the containers for reading ID information.

10. An electronic rack, comprising:
a frame with a plurality of containers, each provided with corresponding position information and configured for receiving a wafer carrier with corresponding process information stored in a database;
a sensor associated with one of the containers, for reading ID information corresponding to a wafer carrier received by the associated container; and
a communication unit transmitting the ID information and corresponding position information of the container to update corresponding process information of the wafer carrier in the database.

11. The electronic rack as claimed in claim 10, wherein the communication unit transmitting the ID information and the corresponding position information through a channel to a server for executing query actions and receive query result from a server

12. The electronic rack as claimed in claim 11, further comprising:
a display showing a portion of the corresponding process information of the wafer carrier.

13. The electronic rack as claimed in claim 12, further comprising:
an output unit writing the portion of the corresponding process information to a storage medium associated with the container.

14. The electronic rack as claimed in claim 13, wherein the wafer carrier received by the associated container comprises a door with a door cover made up of transparent materials.

15. The electronic rack as claimed in claim 14, wherein the wafer carrier received by the associated container comprises a door with a door cover on which a tag holder is formed for holding an RFID tag storing the ID information corresponding to the wafer carrier.

16. The electronic rack as claimed in claim 12, wherein the channel comprises a wire or a wireless channel.

17. The electronic rack as claimed in claim 11, wherein the communication unit converts the ID information from a first protocol for the sensor to a second protocol for the channel, and converts the related information of the wafer carrier from the second protocol to a third protocol for the display.

18. The electronic rack as claimed in claim 17, wherein the display continues displaying related information when an RFID tag comprising the ID information and attached to the wafer carrier is in the read range of the RFID reader.

19. The electronic rack as claimed in claim 18, wherein the RFID reader connects to a plurality of antennas serving as sensors associated one-to-one with the containers for reading ID information.

20. The electronic rack as claimed in claim 18, wherein the RFID antennas comprising radio frequency substantially ≦125 KHz
